(19) United States
(12) Patent Application Publication
(10) Pub. No.: US 2023/0314164 A1
(43) Pub. Date: Oct. 5, 2023

(54) MAP GENERATION APPARATUS

(71) Applicant: Honda Motor Co., Ltd., Tokyo (JP)

(72) Inventor: Yuki Okuma, Wako-shi, Saitama (JP)

(73) Assignee: Honda Motor Co., Ltd., Tokyo (JP)

(21) Appl. No.: 18/124,510

(22) Filed: Mar. 21, 2023

(30) Foreign Application Priority Data
Mar. 31, 2022 (JP) 2022-057884

(51) Int. Cl. G01C 21/00; B60W 30/18; G06V 20/56

(52) U.S. Cl. CPC G01C 21/3815; G01C 21/3833; B60W 30/18154; G06V 20/588; B60W 2420/42; B60W 2552/10; B60W 2552/53; B60W 2556/40

(57) ABSTRACT

A map generation apparatus including an external circumstance detection part and a microprocessor. The microprocessor is configured to perform detecting a travel trace of a subject vehicle, associating a front lane before entering an intersection with a rear lane after passing through the intersection, and generating a map of a traveling lane from the front lane to the rear lane. The traveling lane includes a first lane and a second lane adjacent to the first lane or branching from the first lane. The microprocessor is configured to perform the associating including associating a first front lane with a first rear lane based on the travel trace and associating a second front lane adjacent to the first front lane with the second rear lane adjacent to the first rear lane or the first front lane with the second rear lane based on the external circumstance.

### CROSS-REFERENCE TO RELATED APPLICATION

This application is based upon and claims the benefit of priority from Japanese Patent Application No. 2022-057884 filed on Mar. 31, 2022, the content of which is incorporated herein by reference.

### BACKGROUND OF THE INVENTION

### Field of the Invention

This invention relates to a map generation apparatus configured to generate a map including a division line of a road map.

### Description of the Related Art

At this type of apparatus, conventionally, there is a known apparatus that is configured to recognize a division line (a white line) using an image captured by a camera mounted on a vehicle, and use a recognition result of the division line for a vehicle travel control. Such an apparatus is disclosed, for example, in Japanese Unexamined Patent Publication No. 2014-104853 (JP2014-104853A). The apparatus disclosed in JP2014-104853A extracts an edge point at which a change in luminance in the captured image is equal to or greater than a threshold, and recognizes a division line based on the edge point.

Incidentally, since the dividing line is temporarily interrupted in an intersection, it is preferable to connect dividing lines before and after the intersection in order to specify a traveling lane passing through the intersection. However, there is a case where it is difficult to smoothly connect dividing lines before and after the intersection, such as a case where lanes are offset in a width direction at an entrance and an exit of the intersection. In such a case, it is difficult to generate a map for specifying a traveling lane.

### SUMMARY OF THE INVENTION

An aspect of the present invention is a map generation apparatus including an external circumstance detection part detecting an external circumstance around a subject vehicle; and an electronic control unit including a microprocessor and a memory connected to the microprocessor. The microprocessor is configured to perform: detecting a travel trace of the subject vehicle; associating a front lane representing a traveling lane before entering the intersection with a rear lane representing a traveling lane after passing through the intersection, based on the external circumstance and the travel trace; and generating a map including position information of a traveling lane from the front lane to the rear lane associated with each other. The traveling lane from the front lane to the rear lane includes a first lane on which the subject vehicle has traveled, and a second lane adjacent to the first lane or branching from the first lane, a vehicle traveling direction on the first lane and a vehicle traveling direction on the second lane are identical to each other, the front lane includes a first front lane and a second front lane adjacent to the first front lane, and the rear lane includes a first rear lane and a second rear lane adjacent to the first rear lane. The microprocessor is configured to perform the associating including associating the first front lane with the first rear lane based on the travel trace, and associating the second front lane with the second rear lane or the first front lane with the second rear lane based on the external circumstance.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system having a map generation apparatus according to an embodiment of the present invention;

FIG. 2 is a view illustrating an example of a travel scene to which the map generation apparatus according to the embodiment of the present invention is applied;

FIG. 3A is a diagram illustrating an example of a problem facing a map generation apparatus;

FIG. 3B is a diagram illustrating another example of a problem facing a map generation apparatus;

FIG. 4 is a block diagram illustrating a main configuration of the map generation apparatus according to the embodiment of the present invention;

FIG. 5A is a diagram illustrating an example of an operation obtained by the map generation apparatus according to the embodiment of the present invention;

FIG. 5B is a diagram illustrating another example of an operation obtained by the map generation apparatus according to the embodiment of the present invention; and

FIG. 6 is a flowchart illustrating an example of a processing executed by a controller in FIG. 4.

### DETAILED DESCRIPTION OF THE INVENTION

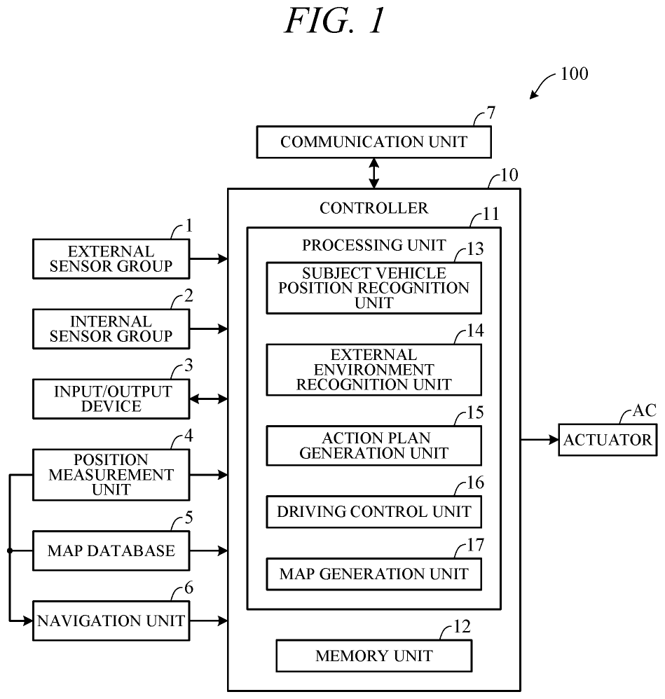

Hereinafter, an embodiment of the present invention is explained with reference to FIGS. 1 to 6. A map generation apparatus according to an embodiment of the invention is configured to generate a map (an environment map described later) used, for example, when a vehicle having a self-driving capability, i.e., self-driving vehicle travels. The vehicle having the map generation apparatus may be sometimes called “subject vehicle” to differentiate it from other vehicles.

The map generation apparatus generates the map when the subject vehicle is manually driven by a driver. Therefore, the map generation apparatus is provided with a manual driving vehicle not having the self-driving capability. The map generation apparatus can be provided with not only the manual driving vehicle, but also the self-driving vehicle capable of switching from a self-drive mode in which a driving operation by the driver is unnecessary to a manual drive mode in which the driving operation by the driver is necessary. In the following, an example of the map generation apparatus provided with the self-driving vehicle will be described.

First, a configuration of the self-driving vehicle will be explained. The subject vehicle is an engine vehicle having an internal combustion engine (engine) as a travel drive source, electric vehicle having a travel motor as the travel drive source, or hybrid vehicle having both of the engine and the travel motor as the travel drive source. FIG. 1 is a block diagram schematically illustrating an overall configuration of a vehicle control system 100 of the subject vehicle having the map generation apparatus according to an embodiment of the present invention.

As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The position measurement sensor may be included in the internal sensor group 2. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a magnetic disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data. The subject vehicle can also communicate with the other vehicle via the communication unit 7.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information). This road map information includes information on road position, information on road shape (curvature, etc.), information on gradient of the road, information on position of intersections and branches, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The map information stored in the memory unit 12 includes map information acquired from the outside of the subject vehicle through the communication unit 7, and map information created by the subject vehicle itself using the detection values of the external sensor group 1 or the detection values of the external sensor group 1 and the internal sensor group 2. Travel history information including detection values of the external sensor group 1 and the internal sensor group 2 corresponding to the map information is also stored in the memory unit 12.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. Optionally, when the subject vehicle position can be measured by sensors installed externally on the road or by the roadside, the subject vehicle position can be recognized by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines (white lines, etc.) and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, points on the edges or an intersection of the edges, and corresponds to a division line on the road surface, a corner of a building, a corner of a road sign, or the like. The map generation unit 17 determines distances to the extracted feature points and sequentially plots the extracted feature points on the environment map by using the distances, thereby generating the environment map around the road on which the subject vehicle has traveled. The environment map may be generated by extracting the feature points of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM (Simultaneous Localization and Mapping) using signal from the camera or the LIDAR, or the like. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

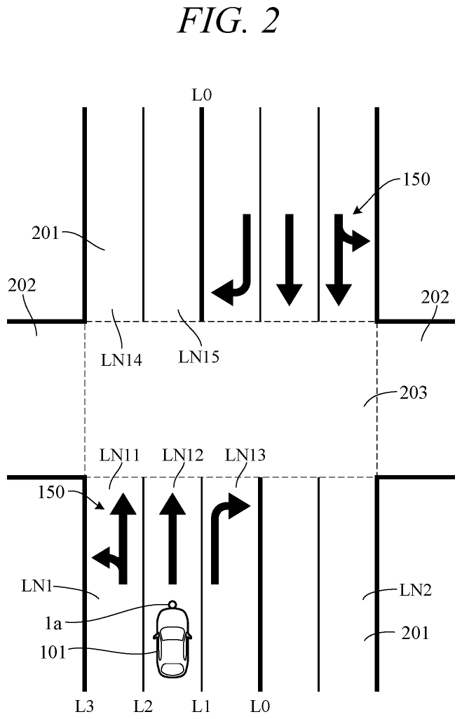

Next, a configuration of the map generation apparatus according to the present embodiment, that is, the map generation apparatus of the vehicle control system 100, will be described. FIG. 2 is a diagram illustrating an example of a road 200 to which the map generation apparatus according to the present embodiment is applied. The road 200 is a road in a country where left-hand traffic is adopted. The map generation apparatus 20 can be similarly applied to a road in a country where right-hand traffic is adopted. FIG. 2 illustrates an intersection 203 (dotted line area) where a first road 201 and a second road 202 are orthogonal to each other. The first road 201 includes a plurality of lanes. Note that illustration of a lane of the second road 202 is omitted.

The first road 201 includes a plurality of traveling lanes LN1 on a side where a subject vehicle 101 is located and a plurality of opposite lanes LN2 facing the traveling lanes LN1. The traveling lane LN1 and the opposite lane LN2 are partitioned with a center line L0 as a boundary, and a vehicle traveling direction along the traveling lane LN1 and a vehicle traveling direction along the opposite lane LN2 are opposite to each other. The traveling lane LN1 and the opposite lane LN2 are defined by left and right division lines except for the intersection 203. Hereinafter, the traveling lane LN1 before the intersection 203 (in front of the intersection 203) is referred to as a front lane for convenience, and the traveling lane LN1 after the intersection 203 (beyond the intersection 203) is referred to as a rear lane for convenience.

The front lane includes three lanes LN11 to L13, and the rear lane includes two lanes LN14 and L15. A vehicle traveling direction at the intersection 203 is defined by the front lanes LN11 to LN13. In other words, the lane LN11 is a lane for traveling straight and turning left, the lane LN12 is a lane for traveling straight, and the lane LN13 is a lane for turning right. As illustrated in FIG. 2, a road surface mark 150 indicating a direction in which the subject vehicle 101 can travel by an arrow is drawn on each of the road surfaces of the front lanes LN11 to LN13.

Since a division line that defines a traveling lane is interrupted at the intersection 203, it is necessary to associate the front lane with the rear lane in order to form a traveling lane across the intersection 203. In an example of FIG. 2, the lane LN11 and the lane LN14 are associated with each other, and the lane LN12 and the lane LN15 are associated with each other. Therefore, the lane LN11 and the lane LN14 are connected via a virtual division line in the intersection 203. The lane LN12 and the lane LN15 are connected via a virtual division line in the intersection 203. Thus, traveling lanes adjacent to each other are formed. The position information of the traveling lane formed in this manner is stored in the memory unit 12 as part of the map information. As a result, when the subject vehicle 101 travels in the self-drive mode, a target trace for passing through the intersection 203 can be generated on the basis of the stored map information.

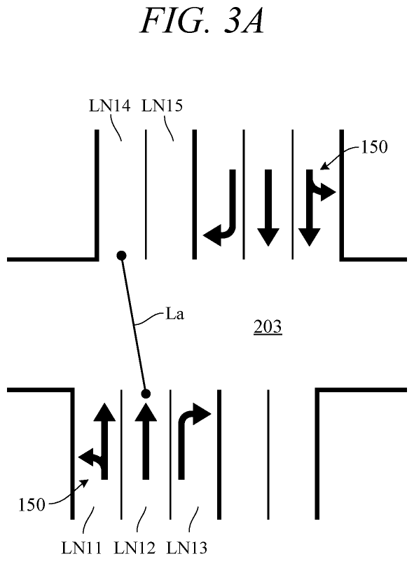

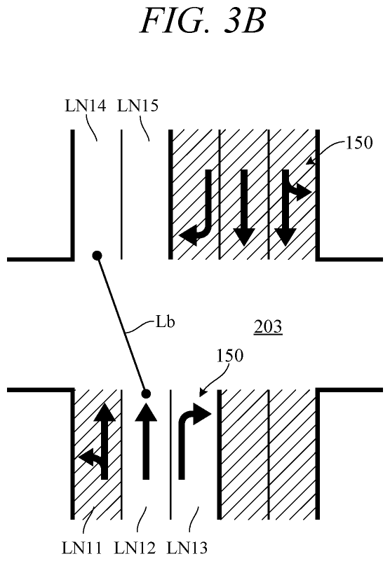

In order to define the traveling lane, it is necessary for the controller 10 to associate lanes before and after the intersection 203. For example, as illustrated in FIG. 2, if a center position in a width direction of the lane LN14 is present on an extension line of a center position in a width direction of the lane LN11, the controller 10 can easily associate the lane LN11 with the lane LN14. If a center position in a width direction of the lane LN15 is present on an extension line of a center position in a width direction of the lane LN12, the controller 10 can easily associate the lane LN12 with the lane LN15. Meanwhile, for example, as illustrated in FIG. 3A, it is difficult to perform association in a case of an offset intersection 203 where a center position in a width direction of a lane LN14 is offset in a left-right direction from an extension line of a center position in a width direction of a lane LN11, and a center position in a width direction of a lane LN15 is offset in a left-right direction from an extension line of a center position in a width direction of the lane LN12. As a result, as indicated by a connection line La, a front lane (lane LN12) and a rear lane (lane LN14) may be erroneously associated with each other.

In addition, another vehicle or the like around the subject vehicle 101 may become an obstacle, and the external sensor group 1 may not recognize a lane (division line) around the subject vehicle 101. For example, in a case where the subject vehicle 101 is located in a lane LN12, lanes in an area indicated by hatching may not be recognized as illustrated in FIG. 3B. Also in this case, as indicated by a connection line Lb, the front lane (lane LN12) and a rear lane (lane LN14) may be erroneously associated with each other. Therefore, in order to be able to accurately associate lanes across the intersection 203, the present embodiment configures the map generation apparatus 20 as follows.

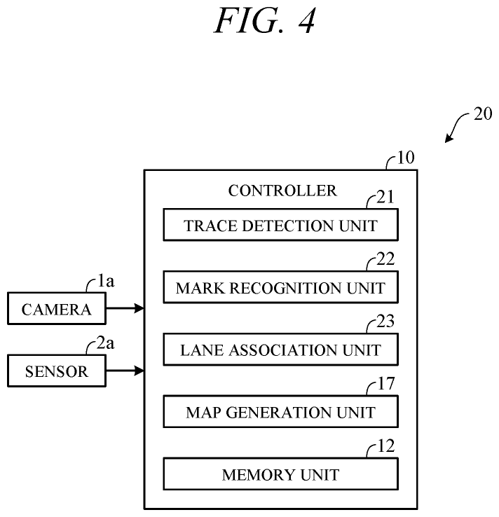

FIG. 4 is a block diagram illustrating the configuration of main parts of a map generation apparatus 20 according to the present embodiment. The map generation apparatus 20 is included in the vehicle control system 100 in FIG. 1. As illustrated in FIG. 4, the map generation apparatus 20 has a camera 1a, a sensor 2a and a controller 10. The camera 1a is a monocular camera having an imaging element (image sensor) such as a CCD or a CMOS, and constitutes a part of the external sensor group 1 in FIG. 1. The camera 1a may be a stereo camera. The camera 1a is attached to, for example, a predetermined position in the front portion of the subject vehicle 101 as shown in FIG. 2, continuously captures an image of a space in front of the subject vehicle 101, and acquires an image (camera image) of a target object. The target object includes the division lines L1 to L3, the center line L0 and the road surface marks. Instead of the camera 1a or in addition to the camera 1a, a detection part such as a LIDAR may be used to detect a target object.

The sensor 2a is a detection part used to calculate a movement amount and a movement direction of the subject vehicle 101. The sensor 2a is a part of the internal sensor group 2, and includes, for example, a vehicle speed sensor and a yaw rate sensor. That is, the controller 10 (subject vehicle position recognition unit 13) calculates the movement amount of the subject vehicle 101 by integrating a vehicle speed detected by the vehicle speed sensor, and calculates a yaw angle by integrating the yaw rate detected by the yaw rate sensor. Further, the controller 10 estimates the position of the subject vehicle 101 by odometry when the map is created. Note that the configuration of the sensor 2a is not limited thereto, and the position of the subject vehicle may be estimated using information of other sensor.

The controller 10 in FIG. 4 has a trace detection unit 21, a mark recognition unit 22, and a lane association unit 23 in addition to the memory unit 12 and the map generation unit 17, as a functional configuration of a processing unit 11 (FIG. 1). Since the trace detection unit 21, the mark recognition unit 22 and the lane association unit 23 have a map generation function, these are included in the map generation unit 17 in FIG. 1.

The memory unit 12 stores map information. The stored map information includes map information (referred to as external map information) acquired from the outside of the subject vehicle 101 through the communication unit 7, and map information (referred to as internal map information) created by the subject vehicle itself. The external map information is, for example, information of a map (called a cloud map) acquired through a cloud server, and the internal map information is information of a map (called an environment map) consisting of point cloud data generated by mapping using a technique such as SLAM (Simultaneous Localization and Mapping). The external map information is shared by the subject vehicle 101 and other vehicles, whereas the internal map information is unique map information of the subject vehicle 101 (e.g., map information that the subject vehicle has alone). The memory unit 12 also stores information on various control programs and thresholds used in the programs.

The trace detection unit 21 detects a travel trace of the subject vehicle 101 at the time of map generation on the basis of signals from the camera 1a and the sensor 2a. When the map information includes a plurality of traveling lanes, the travel trace includes position information of a traveling lane on which the subject vehicle 101 has traveled. The trace detection unit 21 may detect a travel trace by a signal from the position measurement unit 4. The detected travel trace is stored in the memory unit 12.

On the basis of an image (camera image) acquired by the camera 1a, the mark recognition unit 22 recognizes the division lines L1 to L3 and the center line L0, and also recognizes the road surface mark 150 drawn on the front lane. As illustrated in FIG. 2, the road surface mark 150 includes arrows indicating traveling straight, turning left, and turning right. The mark recognition unit 22 recognizes the division line and the road surface mark 150 not only for a current lane on which the subject vehicle 101 travels but also for an adjacent lane adjacent to the current lane and a lane outside the adjacent lane (for example, the opposite lane LN2).

The lane association unit 23 associates the front lane before entering the intersection 203 with the rear lane after passing through the intersection 203. As a result, a traveling lane that passes through the intersection 203 and reaches from the front lane to the rear lane is defined. A specific example of association of lanes will be described.

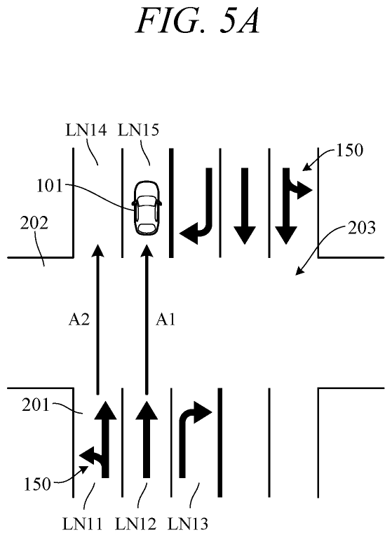

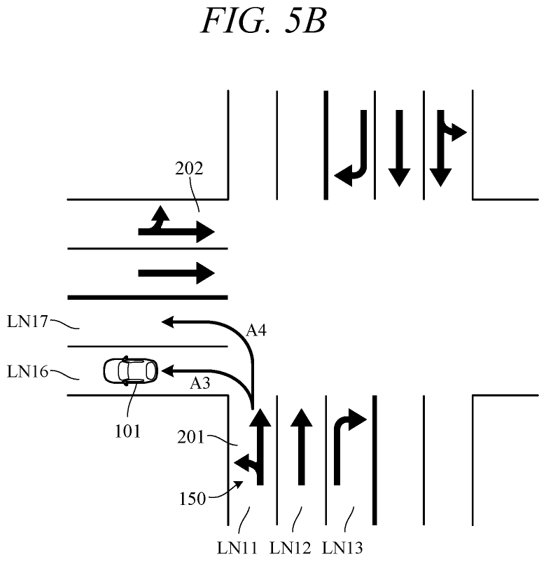

FIG. 5A is a diagram illustrating an example of association of lanes before and after an intersection 203 during traveling straight. As illustrated in FIG. 5A, the lane association unit 23 first associates a front lane LN12 on which the subject vehicle 101 has traveled with a rear lane LN15, on the basis of a travel trace of the subject vehicle 101 during traveling in the manual drive mode detected by the trace detection unit 21. As a result, a traveling lane A1 indicated by an arrow is defined from the front lane LN12 to the rear lane LN15, that is, between the lanes LN12 and LN15. The lanes LN12 and L15 are lanes on which the subject vehicle 101 has traveled and are included in a current lane (traveling lane A1).

Furthermore, the lane association unit 23 determines whether there are road surface marks 150 that define the same traveling direction as the traveling direction of the current lane A1 in the lanes LN11 and LN13 adjacent to the current lane A1, on the basis of the road surface marks 150 of the front lanes LN11 to LN13 recognized by the mark recognition unit 22. Of the lanes LN11 and LN13, the road surface mark 150 of the lane LN11 includes a road surface mark 150 of a straight traveling direction, as with the current lane A1. In this manner, in a case where there is a road surface mark 150 that defines the same traveling direction as the traveling direction of the current lane A1, the lane association unit 23 associates the lane LN11 and a lane LN14 that are adjacent to the current lane A1 on the same side in a left-right direction. As a result, a traveling lane A2 indicated by an arrow is defined from the front lane LN11 to the rear lane LN14, that is, between the lanes LN11 and LN14. The traveling lane A2 is an adjacent lane adjacent to the current lane A1.

FIG. 5A illustrates an example of a case where the number of front lanes in a straight traveling direction is plural (two lanes), and the number of lanes is the same as the number of rear lanes. In this case, as described above, the lane association unit 23 associates the lane LN12 with the lane LN15 on the basis of the travel history of the subject vehicle 101, and associates the lane LN11 adjacent to the lane LN12 with the LN14 adjacent to the lane the LN15. In other words, the lane association unit 23 associates a plurality of lanes across the intersection 203 with each other.

In a case the subject vehicle 101 turns left at the intersection 203 and enters a second road 202 from a first road 201, the front lane becomes a lane on the first road 201, and the rear lane becomes a lane on the second road 202. In this case, if the number of front lanes in a left-turn direction is plural (for example, two lanes) and the number of lanes is the same as the number of rear lanes on the second road 202, the front lane and the rear lane are associated with each other in a manner similar to that described above. In other words, the lane association unit 23 associates the front lane on the first road 201 with the rear lane on the second road 202 on the basis of travel history, and associates other lanes adjacent to the associated lanes with each other. Also, in a case where the number of front lanes in a right-turn direction is plural and the subject vehicle 101 turns right at the intersection 203 and enters the second road 202 from the first road 201, the lane association unit 23 similarly associates a plurality of front lanes with a plurality of rear lanes.

FIG. 5B illustrates an example of a case where the subject vehicle 101 turns left at an intersection 203 and moves from a lane LN11 to a lane LN16. The lane LN16 is adjacent to a lane LN17 in the same traveling direction as the traveling direction of the lane LN16, and the subject vehicle 101 can also travel along the lane LN17 instead of the lane LN16 after turning left. In this manner, in a case where the number of rear lanes is larger than the number of front lanes, the lane association unit 23 associates a front lane LN11 on which the subject vehicle 101 has traveled with the rear lane LN16, on the basis of the travel history of the subject vehicle 101. As a result, a traveling lane A3 (current lane) indicated by an arrow is defined from the front lane LN11, for example, to the rear lane LN16.

Furthermore, the lane association unit 23 determines whether there is a road surface mark 150 that defines the same traveling direction as the traveling direction of the current lane A3 in the lane LN12 adjacent to the current lane A3 among road surface marks 150 of front lanes LN11 to LN13 recognized by the mark recognition unit 22. In the example of FIG. 5B, there is no road surface mark 150 that defines the same traveling direction (left turning) in the lane LN12. Therefore, the lane association unit 23 determines whether there is another lane that is a rear lane extending in the same traveling direction as the traveling direction of the current lane A3. Since there is another lane LN17 in FIG. 5B, the lane association unit 23 associates not only the lane LN16 but also the lane LN17 with the lane LN11. As a result, a traveling lane A4 indicated by an arrow is defined from the front lane LN11 to the rear lane LN17. The traveling lane A4 is a branch lane branching from the current lane A3.

In this manner, in a case where the number of rear lanes (the number of lanes after turning left) is larger than the number of front lanes (the number of lanes for turning left), the lane association unit 23 associates the front lane and the rear lane, whereby in addition to the traveling lane A3 based on the travel history, the traveling lane A4 branching from the traveling lane A3 is defined. Note that not only in a case where the subject vehicle 101 turns left but also in a case where the subject vehicle 101 travels straight and in a case where the subject vehicle 101 turns right, a front lane and a rear lane are similarly associated by the lane association unit 23. As a result, in addition to a traveling lane (current lane) based on travel history, a traveling lane (branch lane) branching from the traveling lane is defined.

The map generation unit 17 generates a map including position information of the traveling lane from the front lane to the rear lane associated by the lane association unit 23 on the basis of the signals from the camera 1a and the sensor 2a. For example, as illustrated in FIG. 5A, a map for traveling straight including position information of the current lane A1 based on the travel history of the subject vehicle 101 and a map for traveling straight including position information of the adjacent lane A2 adjacent to the current lane A1 are generated. Alternatively, as illustrated in FIG. 5B, a map for turning left including position information of the current lane A3 based on the travel history and a map for turning left including position information of the branch lane A4 branching from the current lane A3 are generated. The maps generated by the map generation unit 17 are stored in the memory unit 12.

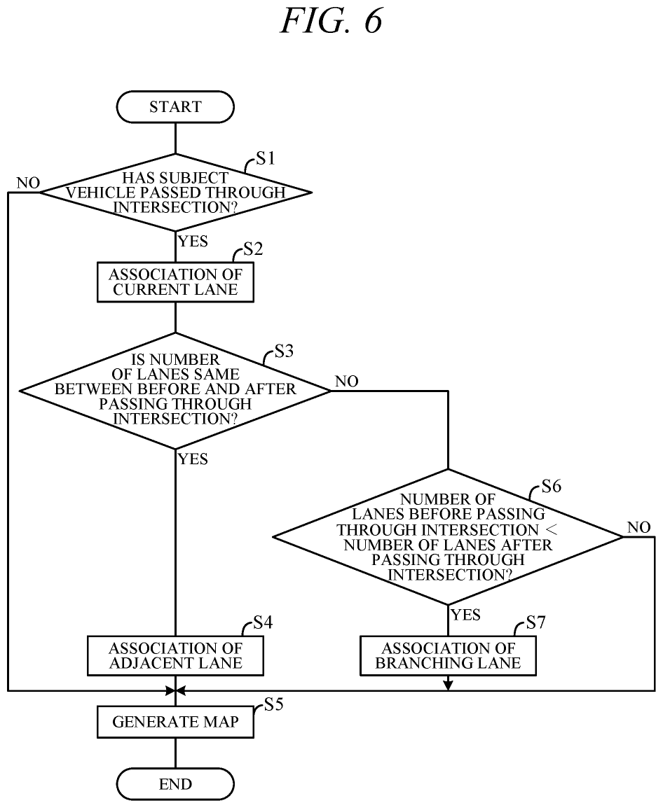

FIG. 6 is a flowchart illustrating an example of processing performed by the controller 10 (CPU) in FIG. 4 in accordance with a predetermined program. The processing illustrated in this flowchart is, for example, started when the subject vehicle 101 traveling in the manual drive mode enters the intersection 203 and is repeated at a predetermined cycle until the subject vehicle 101 passes through the intersection 203 in order to generate an environment map.

Before the subject vehicle 101 enters the intersection 203, left and right division lines that define the current lane are detected by the camera 1a. Furthermore, when the subject vehicle 101 approaches the intersection 203, the road surface mark 150 that defines the traveling direction of the subject vehicle 101 is detected by the camera 1a. Therefore, when the left and right division lines are no longer detected after the road surface mark 150 is detected on the road surface of the front lane, it is determined that the subject vehicle 101 has entered the intersection 203. It is also possible to determine whether the subject vehicle 101 has entered the intersection 203 by detecting a traffic light, a stop line, a crosswalk, or the like with camera 1a. Until the subject vehicle 101 enters the intersection 203, a traveling lane is defined by the left and right division lines, and a map including position information of the traveling lane is generated on the basis of the signals from the camera 1a and the sensor 2a. The traveling lane in this case includes an adjacent lane and an opposite lane in addition to the current lane.

As illustrated in FIG. 6, first, in S1 (S: processing step), the controller 10 determines whether the subject vehicle 101 has passed through the intersection 203 on the basis of the camera image. For example, when a division line of the rear lane is detected on the basis of the camera image and the subject vehicle 101 reaches the division line of the rear lane, it is determined that the subject vehicle 101 has passed through the intersection 203. If an affirmative decision is made in S1, the processing proceeds to S2, while if a negative decision is made in S1, the processing proceeds to S5. In S5, the controller 10 generates a map on the basis of the signals from the camera 1a and the sensor 2a. However, in a state in which the determination is negative in S1, a map of the traveling lane in the intersection 203 is not yet generated.

In S2, the controller 10 detects a travel trace of the subject vehicle 101 on the basis of the signals from the camera 1a and the sensor 2a, recognizes the road surface mark 150 of the front lane on which the subject vehicle 101 has traveled, and then associates the front lane on which the subject vehicle 101 has traveled with the rear lane. Next, in S3, the controller 10 determines whether the number of lanes extending in the same direction as the traveling direction of the subject vehicle 101 is the same between before and after passing through the intersection 203 on the basis of the camera image. In other words, the controller 10 recognizes the number of lanes extending in the same direction as the traveling direction of the subject vehicle 101 on the basis of the road surface mark 150 in the front lane, and further determines whether this recognized number of lanes is the same as the number of lanes in the rear lane recognized at the time of passing through the intersection 203. This determination is a determination as to whether there is an adjacent lane (for example, A2 in FIG. 5A) extending in the same direction as the direction of the current lane (for example, A1 in FIG. 5A) on which the subject vehicle 101 has traveled, regardless of traveling straight, turning left, or turning right. If an affirmative decision is made in S3, the processing proceeds to S4, while if a negative decision is made, the processing proceeds to S6.

In S4, the controller 10 associates a front lane adjacent to a front lane on which the subject vehicle 101 has traveled (for example, the LN11 in FIG. 5A; referred to as an adjacent front lane) with a rear lane adjacent to a rear lane on which the subject vehicle 101 has traveled (for example, the LN14 in FIG. 5A; referred to as adjacent rear lane).

That is, association such that a lane becomes an adjacent lane adjacent to the current lane is performed. The adjacent front lane and the adjacent rear lane that are associated with each other are lanes located on the same side in the left-right direction of the current lane. Next, in S5, the controller 10 generates a map including position information of the traveling lane from the front lane to the rear lane associated in S2 and S4.

In S6, the controller 10 determines whether the number of lanes extending in the same direction as the traveling direction of the subject vehicle 101 before passing through the intersection 203 is smaller than the number of lanes extending in the same direction as the traveling direction of the subject vehicle 101 after passing through the intersection 203. For example, when there is no other front lane extending in the same direction as the traveling direction of the subject vehicle 101 (there is no adjacent front lane) and there is another rear lane extending in the same direction as the traveling direction of the subject vehicle 101 (when there is an adjacent rear lane), an affirmative decision is made in S6 and the processing proceeds to S7. Meanwhile, if a negative decision is made in S6, the processing proceeds to S5.

In S7, the controller 10 associates the front lane on which the subject vehicle 101 has traveled with the rear lane (adjacent rear lane) adjacent to the rear lane on which the subject vehicle 101 has traveled. That is, association such that a lane becomes a branching lane (for example, A4 in FIG. 5B) branching from the current lane (for example, A3 in FIG. 5B) is performed. When the number of front lanes extending in the same direction as the traveling direction of the subject vehicle 101 is plural (for example, two lanes) and the number of rear lanes extending in the same direction as the traveling direction of the subject vehicle 101 is larger than the number of the plurality of front lanes (for example, three lanes), the controller 10 associates the front lane on which the subject vehicle 101 has traveled with a rear lane adjacent to or not adjacent to the rear lane on which the subject vehicle 101 has traveled. In other words, the controller 10 associates the front lane on which the subject vehicle 101 has traveled with a rear lane on which the subject vehicle 101 has not traveled but the subject vehicle 101 can travel. At this time, a front adjacent lane adjacent to the current lane is similarly associated with a plurality of rear lanes. Next, in S5, the controller generates a map including position information of the traveling lane from the front lane to the rear lane associated in S2 and S7.

The operation of the map generation apparatus 20 according to the present embodiment will be described more specifically. While the subject vehicle 101 travels in the manual drive mode, an environment map around the subject vehicle 101 is generated on the basis of the signals from the camera 1a and the sensor 2a. At this time, for example, after traveling on the front lane LN12 of the first road 201 illustrated in FIG. 5A, when the subject vehicle 101 passes through the intersection 203 and reaches the rear lane LN15, the front lane LN12 and the rear lane LN15 are associated with each other on the basis of a travel trace of the subject vehicle 101 (S2). As a result, the environment map including map information of the traveling lane A1 during traveling straight, which connects the front lane LN12 and the rear lane LN15, is generated (S5).

At this time, when the subject vehicle 101 travels on the front lane LN12, the front lane LN11 in which the road surface mark 150 of a straight traveling direction similar to that of the front lane LN12 is drawn, is recognized on the basis of the camera image. As a result, the front lane LN11 and the rear lane LN14 adjacent to the current lane A1 are associated with each other, and the environment map including map information of the traveling lane A2 adjacent to the current lane A1, which connects the front lane LN11 and the rear lane LN14, is generated (S4, S5). As a result, it is possible to satisfactorily generate the environment map at the intersection 203 where a division line is interrupted on the basis of the travel trace of the subject vehicle 101 and the camera image. The generated map is stored in the memory unit 12 and used when the subject vehicle 101 travels in the self-drive mode.

As illustrated in FIG. 5B, when the subject vehicle 101 turns left at the intersection 203 and moves from the front lane LN11 to the rear lane LN16, the front lane LN11 and the rear lane LN16 are associated with each other on the basis of a travel trace of the subject vehicle 101 (S2), similarly to during traveling straight. As a result, an environment map including map information of the traveling lane A3 during turning left and traveling, which connects the front lane LN11 and the rear lane LN16, is generated (S5).

At this time, the road surface mark 150 for turning left is drawn only on the current lane A3, but not only the current lane LN16 but also the adjacent lane LN17 exist as the rear lane on the second road 202 after turning left. Therefore, the front lane LN11 and the rear lane LN17 are associated with each other, and an environment map including map information of the traveling lane A4 branching from the current lane A3, which connects the front lane LN11 and the rear lane LN17, is generated (S7, S5). As a result, even in a case where the number of lanes before the intersection 203 is not the same as the number of lanes after the intersection 203, it is possible to satisfactorily generate an environment map at the intersection 203 where a division line is interrupted, on the basis of the travel trace of the subject vehicle 101 and the camera image.

The present embodiment is capable of achieving the following operations and effects.

(1) The map generation apparatus 20 includes the camera 1a, the trace detection unit 21, the lane association unit 23, and the map generation unit 17 (FIG. 4). The camera 1a detects an external circumstance around the subject vehicle 101. The trace detection unit 21 detects a travel trace of the subject vehicle 101. The lane association unit 23 associates a front lane that is a traveling lane before entering the intersection 203 with a rear lane that is a traveling lane after passing through the intersection 203 on the basis of the external circumstance detected by the camera 1a and the travel trace detected by the trace detection unit 21. The map generation unit 17 generates a map including position information of a traveling lane from the front lane to the rear lane associated by the lane association unit 23. The traveling lane includes the traveling lane A1 (a first lane) on which the subject vehicle 101 has traveled and the traveling lane A2 (a second lane) adjacent to the traveling lane A1 (FIG. 5A). Alternatively, the traveling lane includes the traveling lane A3 (a first lane) on which the subject vehicle 101 has traveled and the traveling lane A4 (a second lane) branching from the traveling lane A3 (FIG. 5B). A vehicle traveling direction on the traveling lane A1 and a vehicle traveling direction on the traveling lane A2 are the same to each other (FIG. 5A). A vehicle traveling direction on the traveling lane A3 and a vehicle traveling direction on the traveling lane A4 are the same to each other (FIG. 5B). The front lane includes the lane LN11 and the lane LN12 adjacent to each other, and the rear lane includes the lane LN15 (a first rear lane) and the lane LN14 (a second rear lane) adjacent to each other or the lane LN16 (a first rear lane) and the lane LN17 (a second rear lane) adjacent to each other (FIGS. 5A and 5B). The lane association unit 23 associates the front lane LN12 with the rear lane LN15 or associates the front lane LN11 with the rear lane LN16 on the basis of the travel trace detected by the trace detection unit 21 (traveling lanes A1 and A3), and associates the front lane LN11 with the rear lane LN14 or associates the front lane LN11 with the rear lane LN17 on the basis of the external circumstance detected by the camera 1a (traveling lanes A2 and A4).

As a result, even in a case where a lane is offset in a width direction at an entrance and an exit of the intersection 203 (for example, FIG. 3A) or in a case where a lane around the subject vehicle 101 is not recognized on the basis of the camera image due to the presence of an obstacle such as another vehicle around the subject vehicle 101 (for example, FIG. 3B), division lines can be smoothly connected to each other before and after the intersection 203 on the basis of the travel trace of the subject vehicle 101 and the camera image. As a result, it is possible to easily generate a map defining a traveling lane crossing the intersection 203.

(2) The map generation apparatus 20 further includes the mark recognition unit 22 that recognizes the road surface mark 150 indicating a traveling direction on the front lane on the basis of the external circumstance detected by the camera 1a (FIG. 4). When a traveling direction indicated by a road surface mark 150 on the front lane LN12, which is recognized by the mark recognition unit 22, and a traveling direction indicated by a road surface mark 150 on the front lane LN11, which is recognized by the mark recognition unit 22, are the same direction, the lane association unit 23 associates the front lane LN11 with the rear lane LN14 (FIG. 5A). As a result, it is possible to easily and accurately generate map information not only on the traveling lane A1 on which the subject vehicle 101 has actually traveled but also on the traveling lane A2 on which the subject vehicle 101 has not traveled.

(3) The lane association unit 23 associates the front lane LN12 with the rear lane LN15 so that the traveling lane A1 goes straight through the intersection 203 and extends (FIG. 5A). Alternatively, the lane association unit 23 associates the front lane LN11 with the rear lane LN16 so that the traveling lane A3 turns left and extends (FIG. 5B). Although not illustrated, the lane association unit 23 also associates the front lane with the rear lane so that the traveling lane turns right at the intersection 203 and extends. As a result, even in a case where the subject vehicle 101 travels in any direction in the manual drive mode, a map including the traveling lane on the basis of the travel trace of the subject vehicle 101 can be generated.

(4) The front lane LN11 adjacent to the front lane LN12 on which the subject vehicle 101 has traveled and the rear lane LN14 adjacent to the rear lane LN15 on which the subject vehicle 101 has traveled are on the same side in a left-right direction of the front lane LN12 and the rear lane LN15, respectively (FIG. 5A). As a result, it is possible to generate a map of the adjacent lane A2 along the current lane A1 on which the subject vehicle 101 has not traveled.

The above embodiment can be varied into various forms. In the above embodiment, the external circumstance around the subject vehicle 101 is detected by the external sensor group 1 such as a camera 1a, but the external circumstance may be detected by a LIDAR or the like. Therefore, the configuration of an external circumstance detection part is not limited to the above configuration. In the above embodiment, the trace detection unit 21 detects a travel trace of the subject vehicle 101 on the basis of signal from the camera 1a and the sensor 2a, but the configuration of a trace detection unit is not limited to the above configuration. Since the trace detection unit 21 recognizes the travel trace on the basis of signal from the camera 1a and the sensor 2a, the trace detection unit can be replaced with a trace recognition unit. In the above embodiment, the map generation unit 17 generates an external map during traveling in the manual drive mode, but may generate the external map during traveling in the self-drive mode. In the above embodiment, an environment map is generated on the basis of the camera image, the environment map may be generated by extracting feature points of objects around the subject vehicle 101 using data acquired by a radar or LIDAR instead of the camera 1a. Therefore, the configuration unit of a map generation unit is not limited to the above configuration.

In the above embodiment, the lane association unit 23 associates the front lane before entering the intersection 203 with the rear lane after passing through the intersection 203. More specifically, the front lane LN12 (a first front lane) and the rear lane LN15 (a first rear lane) are associated with each other on the basis of the travel trace detected by the trace detection unit 21, and the front lane LN11 (a second front lane) and the rear lane LN14 (a second rear lane) are associated with each other on the basis of the external circumstance detected by the camera 1a (FIG. 5A). Alternatively, the front lane LN11 (a first front lane) and the rear lane LN16 (a first rear lane) are associated with each other on the basis of the travel trace detected by the trace detection unit 21, and the front lane LN11 (a first front lane) and the rear lane LN17 (a second rear lane) are associated with each other on the basis of the external circumstance detected by the camera 1a (FIG. 5B). However, the configuration of a lane association unit is not limited to the above configuration. In the above embodiment, the mark recognition unit 22 recognizes the road surface mark 150 indicating the traveling direction of the front lane on the basis of the external circumstance detected by the camera 1a, but the configuration of a mark recognition unit is not limited to the above configuration.

In the above embodiment, the map generation unit 17 generates the environment map while the subject vehicle 101 is traveling, but data obtained by the camera image during traveling of the subject vehicle 101 may be stored in the memory unit 12, and the environment map may be generated using the stored data after the traveling of the subject vehicle 101 is completed. Therefore, a map may be not generated while traveling.

Although in the above embodiment, the subject vehicle 101 having the self-driving capability includes the function as the map generation apparatus 20, a subject vehicle not having the self-driving capability may include a function as a map generation apparatus. In this case, the map information generated by the map generation apparatus 20 may be shared with another vehicle, and used for a driving assistance of the other vehicle (e.g., self-driving vehicle). That is, the subject vehicle may have only a function as a map generation apparatus.

The present invention can also be used as a map generation method including: detecting an external circumstance around a subject vehicle; detecting a travel trace of the subject vehicle; associating a front lane representing a traveling lane before entering the intersection with a rear lane representing a traveling lane after passing through the intersection, based on the external circumstance and the travel trace; and generating a map including position information of a traveling lane from the front lane to the rear lane associated with each other. The traveling lane from the front lane to the rear lane includes a first lane on which the subject vehicle has traveled, and a second lane adjacent to the first lane or branching from the first lane, a vehicle traveling direction on the first lane and a vehicle traveling direction on the second lane are identical to each other, the front lane includes a first front lane and a second front lane adjacent to the first front lane, the rear lane includes a first rear lane and a second rear lane adjacent to the first rear lane, and the associating includes associating the first front lane with the first rear lane based on the travel trace, and associating the second front lane with the second rear lane or the first front lane with the second rear lane based on the external circumstance.

According to the present invention, it is possible to easily generate a map defining a traveling lane crossing an intersection.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus, comprising:
an external circumstance detection part detecting an external circumstance around a subject vehicle; and
an electronic control unit including a microprocessor and a memory connected to the microprocessor, wherein
the microprocessor is configured to perform:
detecting a travel trace of the subject vehicle;
associating a front lane representing a traveling lane before entering an intersection with a rear lane representing a traveling lane after passing through the intersection, based on the external circumstance and the travel trace; and
generating a map including position information of a traveling lane from the front lane to the rear lane associated with each other,
the traveling lane from the front lane to the rear lane includes a first lane on which the subject vehicle has traveled, and a second lane adjacent to the first lane or branching from the first lane,
a vehicle traveling direction on the first lane and a vehicle traveling direction on the second lane are identical to each other,
the front lane includes a first front lane and a second front lane adjacent to the first front lane,
the rear lane includes a first rear lane and a second rear lane adjacent to the first rear lane, and
the microprocessor is configured to perform
the associating including associating the first front lane with the first rear lane based on the travel trace, and associating the second front lane with the second rear lane or the first front lane with the second rear lane based on the external circumstance.

2. The map generation apparatus according to claim 1, wherein
the microprocessor is configured to further perform
recognizing a road surface mark indicating a traveling direction on the front lane based on the external circumstance, and
the microprocessor is configured to perform
the associating including associating the second front lane with the second rear lane when a traveling direction marked on the first front lane and a traveling direction marked on the second front lane recognized are identical to each other.

3. The map generation apparatus according to claim 1, wherein
the microprocessor is configured to perform
the associating including associating the first front lane with the first rear lane so that the first lane extends traveling straight through the intersection, or turning left or right at the intersection.

4. The map generation apparatus according to claim 1, wherein
the second front lane and the second rear lane are respectively adjacent to the first front lane and the first rear lane in a left-right direction, and
a side on which the second front lane is adjacent to the first front lane is identical to a side on which the second rear lane is adjacent to the first rear lane.

5. The map generation apparatus according to claim 1, wherein
a number of lanes in the front lane is identical to a number of lanes in the rear lane, and
the microprocessor is configured to perform
the associating including associating the first front lane with the first rear lane based on the travel trace, and associating the second front lane with the second rear lane based on the external circumstance.

6. The map generation apparatus according to claim 1, wherein
a number of lanes in the rear lane is more than a number of lanes in the front lane, and
the microprocessor is configured to perform
the associating including associating the first front lane with the first rear lane based on the travel trace, and associating the first front lane with the second rear lane based on the external circumstance.

7. The map generation apparatus according to claim 1, wherein
the first lane extends so as to go straight through the intersection, and
an extending line passing through a center in a left-right direction in the first front lane and extending parallel to the first front lane is offset from a center in the left-right direction in the first rear lane.

8. A map generation apparatus, comprising:
an external circumstance detection part detecting an external circumstance around a subject vehicle; and
an electronic control unit including a microprocessor and a memory connected to the microprocessor, wherein
the microprocessor is configured to function as:
a trace detection unit that detects a travel trace of the subject vehicle;
a lane association unit that associates a front lane representing a traveling lane before entering an intersection with a rear lane representing a traveling lane after passing through the intersection, based on the external circumstance detected by the external circumstance detection part and the travel trace detected by the trace detection unit; and
a map generation unit that generates a map including position information of a traveling lane from the front lane to the rear lane associated by the lane association unit,
the traveling lane from the front lane to the rear lane includes a first lane on which the subject vehicle has traveled, and a second lane adjacent to the first lane or branching from the first lane,
a vehicle traveling direction on the first lane and a vehicle traveling direction on the second lane are identical to each other,
the front lane includes a first front lane and a second front lane adjacent to the first front lane,
the rear lane includes a first rear lane and a second rear lane adjacent to the first rear lane, and
the lane association unit associates the first front lane with the first rear lane based on the travel trace detected by the trace detection unit, and associates the second front lane with the second rear lane or the first front lane with the second rear lane based on the external circumstance detected by the external circumstance detection part.

9. The map generation apparatus according to claim 8, wherein
the microprocessor is configured to further function as
a mark recognition unit that recognizes a road surface mark indicating a traveling direction on the front lane based on the external circumstance detected by the external circumstance detection part, and
the lane association unit associates the second front lane with the second rear lane when a traveling direction marked on the first front lane and a traveling direction marked on the second front lane recognized by the mark recognition unit are identical to each other.

10. The map generation apparatus according to claim 8, wherein
the lane association unit associates the first front lane with the first rear lane so that the first lane extends traveling straight through the intersection, or turning left or right at the intersection.

11. The map generation apparatus according to claim 8, wherein
the second front lane and the second rear lane are respectively adjacent to the first front lane and the first rear lane in a left-right direction, and
a side on which the second front lane is adjacent to the first front lane is identical to a side on which the second rear lane is adjacent to the first rear lane.

12. The map generation apparatus according to claim 8, wherein
a number of lanes in the front lane is identical to a number of lanes in the rear lane, and
the lane association unit associates the first front lane with the first rear lane based on the travel trace detected by the trace detection unit, and associates the second front lane with the second rear lane based on the external circumstance detected by the external circumstance detection part.

13. The map generation apparatus according to claim 8, wherein
a number of lanes in the rear lane is more than a number of lanes in the front lane, and
the lane association unit associates the first front lane with the first rear lane based on the travel trace detected by the trace detection unit, and associates the first front lane with the second rear lane based on the external circumstance detected by the external circumstance detection part.

14. The map generation apparatus according to claim 8, wherein
the first lane extends so as to go straight through the intersection, and
an extending line passing through a center in a left-right direction in the first front lane and extending parallel to the first front lane is offset from a center in the left-right direction in the first rear lane.

15. A map generation method, comprising:
detecting an external circumstance around a subject vehicle;
detecting a travel trace of the subject vehicle;
associating a front lane representing a traveling lane before entering an intersection with a rear lane representing a traveling lane after passing through the intersection, based on the external circumstance and the travel trace; and
generating a map including position information of a traveling lane from the front lane to the rear lane associated with each other, wherein
the traveling lane from the front lane to the rear lane includes a first lane on which the subject vehicle has traveled, and a second lane adjacent to the first lane or branching from the first lane,
a vehicle traveling direction on the first lane and a vehicle traveling direction on the second lane are identical to each other,
the front lane includes a first front lane and a second front lane adjacent to the first front lane,
the rear lane includes a first rear lane and a second rear lane adjacent to the first rear lane, and
the associating includes associating the first front lane with the first rear lane based on the travel trace, and associating the second front lane with the second rear lane or the first front lane with the second rear lane based on the external circumstance.
